(19) United States
(12) Patent Application Publication
(10) Pub. No.: US 2008/0288366 A1
(43) Pub. Date: Nov. 20, 2008

(54) METHOD AND SYSTEM FOR THE EXCHANGE OF GOODS OVER THE INTERNET

(76) Inventors: Gerald Schonbucher, Koln (DE); Andre Alpar, Frankfurt (DE); Jan Miczaika, Koln (DE)

Correspondence Address: PERKINS COIE LLP, P.O. BOX 1208, SEATTLE, WA, 98111-1208, US

(21) Appl. No.: 11/751,006

(22) Filed: May 19, 2007

(51) Int. Cl. G06Q 30/00

(52) U.S. Cl. 705/27

(57) ABSTRACT

The present invention contemplates a computer-implemented, currency-based method and system for the exchange of goods over the internet. The invention provides and maintains an exchange web site and an overall list of items available for exchange. The exchange provides and maintains a medium of exchange, the units of which are termed ‘flips’, and assigns an exchange value in flips to each item offered for exchange. The exchange also provides and maintains an account for each user. The exchange includes a central computer and a database that maintains a separate library for each user that lists all items offered for exchange by that user, and a separate wish list for each user that lists all items desired for exchange by that user. The central computer analyzes data records input by users to find items that have been offered for exchange by at least one user and are desired for exchange by at least one user. When such an item is found, the central computer selects a first user who offers the item and selects a second user who desires the item to participate in an exchange. The central computer sends contact information regarding the second user to the first user and instructs the first user to send the item to the second user. The central computer deducts the cost, in flips, of the item from the account of the second user, credits the cost, in flips, of the item to the account of the first user, and charges a transaction fee to the second user.

### BACKGROUND OF INVENTION

1. Field of Invention

The present invention relates to the exchange of goods over a communications network and more specifically to a computer-implemented currency-based method and system for the exchange of goods over the Internet.

2. Description of Related Art

Before the advent of the internet, individuals wishing to buy, sell, or exchange goods were limited to placing classified advertisements in local newspapers or participating in local exchange clubs such as book clubs. The internet made possible the exchange of goods on a global basis. There are now many computer-driven classified ad sites and electronic bulletin boards that accept advertisements. Online classified ad sites include seller-driven sell-ad sites, and buyer-driven want-ad sites. Exchange sites that match buyers and sellers of property such as real estate have also been proposed. But such sites are designed primarily to enable one-time exchanges and do not readily accommodate regular exchanges.

There also exist swap sites that facilitate trades between two individuals when each desires an item offered by the other. Such swap sites permit the exchange of items such as books, CDs, and DVDs. Users specify items to exchange and are matched by computer, thereby eliminating the need to peruse long lists of goods offered or desired for exchange. However, such sites only permit two- or multi-way exchanges of goods for goods.

What is needed is a site that matches users offering items for exchange with other users desiring those items for exchange, thereby eliminating the need to peruse long lists of items available for exchange, and also permits users to exchange goods for some form of currency that can later be used to obtain other goods at the site. In such a site, a user would simply list an item offered for exchange and wait for the computer to match her with another user who desires that item for exchange. Such a site might provide users with accounts; when an item is transferred, the cost of the item would be deducted from the account of the receiver and credited to the account of the sender. Such accounts would greatly facilitate the exchange of goods on a regular basis.

### SUMMARY OF THE INVENTION

The present invention contemplates a variety of improved methods and systems for the exchange of goods over a communications network. More specifically, the present invention teaches a computer-implemented, currency-based method and system for the exchange of goods over the internet.

The present invention provides and maintains an exchange for the transfer of ownership of items over the internet, including the provision and maintenance of an overall list of items available for exchange; facilities for reception of data entries from users identifying items offered for exchange, where such items are identified by EAN codes or ISBN numbers; and facilities for reception of data entries from users identifying items desired for exchange, where desired items are selected from the overall list of items available for exchange or are specified by EAN codes or ISBN numbers. The exchange maintains and updates a database that contains a separate library for each user that lists all items offered for exchange by that user; a separate wish list for each user that lists all items desired for exchange by that user; a separate watch list for each user that lists items of interest to that user, where items of interest are taken from the overall list of items available for exchange; and a separate task list for each user that lists all outstanding tasks to be performed by that user.

The exchange provides and maintains a medium of exchange, the units of which are termed ‘flips’, and assigns an exchange value in flips to each item in the overall list of items available for exchange. The exchange also provides and maintains an account for each user of the exchange. The exchange also provides and maintains a web site to facilitate the exchange of goods. The overall list of items available for exchange, and the libraries, wish lists, watch lists, and task lists of users are all accessed via web pages on the web site.

A user of the exchange becomes a registered user by providing the exchange with her name, email address, password, and an optional mailing address. Only registered users may participate in exchanges.

Items are exchanged as follows. The Hitflip central computer searches its database to identify items that have been offered for exchange by at least one user and are desired for exchange by at least one user. If such an item is found, the central computer selects a first user who offers the item for exchange and selects a second user who desires the item for exchange to participate in an exchange. The central computer sends contact information, including name and mailing address, of the second user to the first user and instructs the first user to send the item to the second user. The central computer then debits the cost of the item in flips from the account of the second user, credits the cost of the item in flips to the account of the first user, and assesses a transaction fee to the second user. Finally, the central computer notifies the second user when the first user sends the item to the second user.

The system of the present invention includes a central computer, a plurality of remote terminals, a data communication network providing a path for data exchange between the central computer and the remote terminals, a processor located at the central computer, an interface located at the central computer that is capable of providing data to and receiving data from the remote terminals, and a data storage device connected to the central computer that includes a database for the exchange. The central computer receives data entries from users input at the remote terminals that identify items offered for exchange. The processor analyzes data records to determine whether there are data records specifying items offered for exchange as desired for exchange, and, if so, selects users offering and desiring the same items to participate in exchanges.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 is a flow chart illustrating a method of exchange of goods over the internet according to the present invention;

FIG. 2 is a pictorial illustration of the overall list of goods available for exchange;

FIG. 3 is a pictorial illustration of a wish list of goods desired for exchange by a user;

FIG. 4 is a pictorial illustration of an interface for offering goods for exchange;

FIG. 5 is a pictorial illustration of a library of goods offered by a user for exchange;

FIG. 6 is a pictorial illustration of a task list that lists all outstanding tasks to be performed by a user;

FIG. 7 is a pictorial illustration of a watch list of goods of interest to a user;

FIG. 8 is a diagram of the system of the present invention.

### DETAILED DESCRIPTION OF THE INVENTION

The present invention teaches a computer-implemented, currency-based method and system of exchange of goods over the internet.

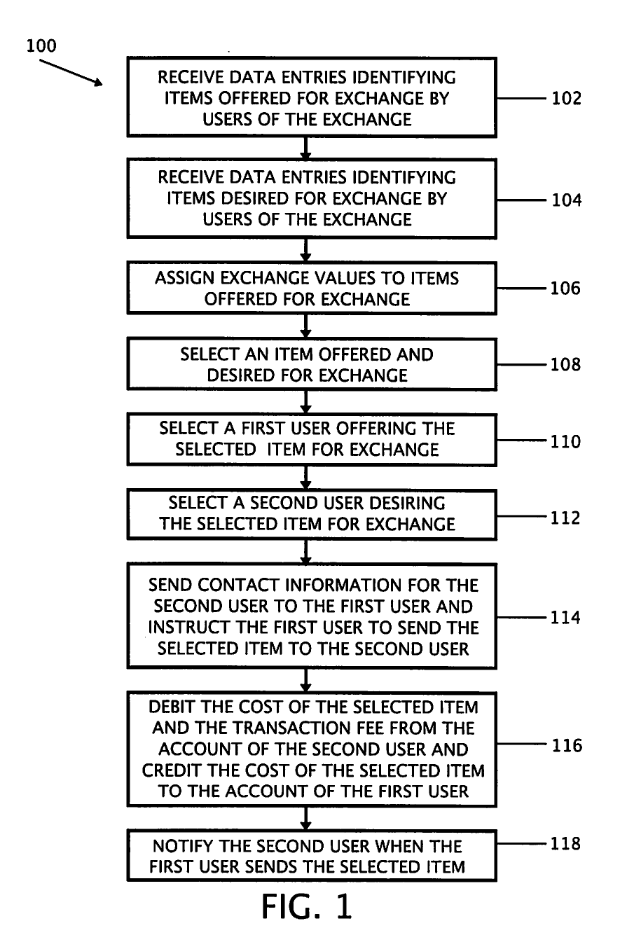

FIG. 1 is a flow chart 100 illustrating the method of exchange of the present invention, according to one embodiment of the invention. In a first step 102, the Hitflip central computer receives data entries identifying items offered for exchange by users of the exchange. In a next step 104, the central computer receives data entries identifying items desired for exchange by users of the exchange.

Continuing in a next step 106, the central computer assigns exchange values to the items offered for exchange. The exchange provides and maintains a medium of exchange, the units of which are termed ‘flips’. The exchange values of items are specified in flips, typically one, two, three, or more flips per item. In another embodiment, a standard currency such as dollars, euros, or pounds, is used to assign exchange values.

Continuing in a next step 108, the central computer selects an item that is offered for exchange by at least one user and is desired for exchange by at least one user. In a next step 110, the central computer selects a first user offering the selected item for exchange to participate in an exchange. In a next step 112, the central computer selects a second user desiring the selected item for exchange to participate in an exchange with the first user. Other users offering and requesting the item are placed on a waiting list. In one embodiment, the criteria used to select users to participate in an exchange of an item are the dates on which those users have offered and requested that item for exchange (if more than one user has offered or requested an item, preference is given to earlier offers and requests); in other embodiments, other criteria, such as past trading performance, may be used. In a next step 114, the central computer sends contact information for the second user, typically the name and mailing address of the second user, to the first user and instructs the first user to send the selected item to the second user.

Continuing in a next step 116, the central computer debits the cost, in flips, of the selected item from the account of the second user and credits the cost, in flips, of the selected item to the account of the first user. In another embodiment, in which a different currency, such as dollars, euros, or pounds, is used, costs debited and credited are specified in that currency. The central computer also assesses a transaction fee to the second user. In a next step, the central computer notifies the second user when the first user sends the selected item.

In a further step (not shown), upon receipt of the selected item, the second user rates the performance of the first user, using an interface provided by Hitflip. The rating simultaneously confirms receipt of the selected item by the second user to the first user. Confirmation of receipt appears in the task list 600 of the first user, shown to the first user in an interface maintained by Hitflip.

In the preferred embodiment, a user registers with the exchange by providing a name, email address, and optional mailing address to the exchange. In the preferred embodiment, only registered users may participate in exchanges. In the preferred embodiment, there is no registration fee.

In the preferred embodiment, when an item is exchanged, the receiver pays a transaction fee and the sender pays the shipping costs but does not pay a transaction fee. There are no other special fees associated with participation in the exchange. Other embodiments involve different payment options. For example, in one embodiment, every user must pay a registration fee to participate in exchanges. In another embodiment, both senders and receivers pay a transaction fee and share the shipping costs.

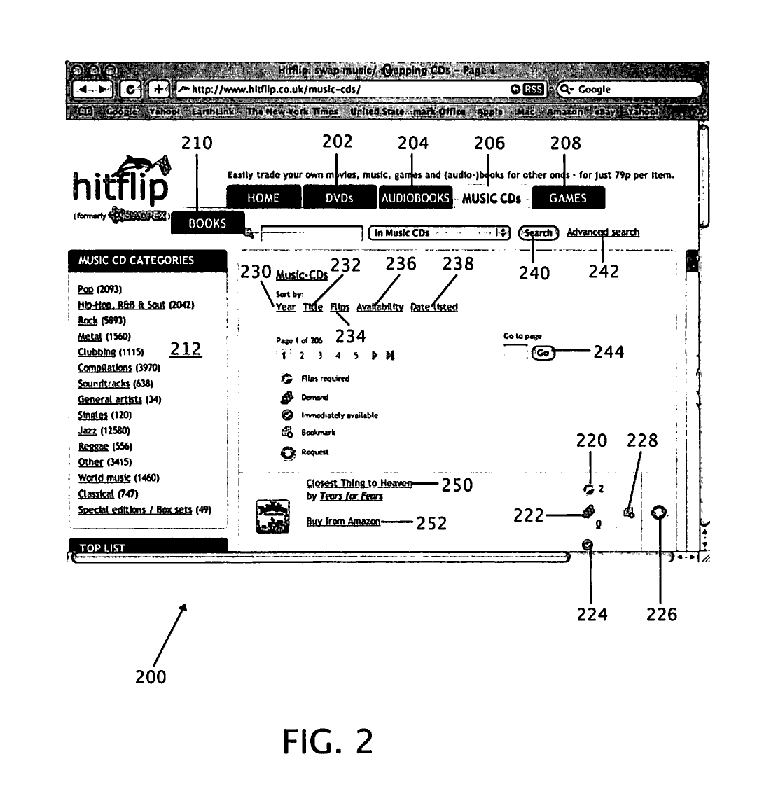

FIG. 2 is a pictorial illustration 200 of the overall list of goods available for exchange, according to a preferred embodiment of the present invention. The overall list 200 includes every item offered for exchange by every user. Whenever a user offers an item for exchange using the interface 400 provided by Hitflip, the item is added to the overall list 200. Whenever a user removes an item offered for exchange, the item is removed from the overall list 200 (unless another user has also offered the same item for exchange).

In the preferred embodiment, the list is divided into the following categories: DVDs 202, Audiobooks 204, Music CDs 206, Games 208, and Books 210. The categories are further divided into subcategories 212, and the list 200 shows the number of items available in each subcategory. Other categories of goods may be specified in other embodiments. However, in embodiments similar to the preferred embodiment, only items having an EAN code or an ISBN number may be offered for exchange, since items are listed by specifying either the EAN code or the ISBN number.

Each listing shows the number of flips 220 required to acquire the listed item, the number of users 222 requesting the listed item, and whether the listed item is immediately available 224 for exchange. If a requested item is immediately available for exchange, the Hitflip central computer selects users offering and requesting the item to participate in exchanges. The user may click on the Request icon 226 to add the listed item to her wish list 300, and may click on the Bookmark icon 228 to add the listed item to her watch list 700. A user can sort the list by year 230, title 232, flips required 234, availability 236, and date listed 238. Search 240 and advanced search features 242 are also available. A user can select 244 a specific page of the list to browse.

In the pictorial illustration 200, the category shown is Music CDs. The first item in the list of music CDs is Closest Thing to Heaven 250, by Tears for Fears. The exchange value of the item is two flips, the item is desired by 0 users, and the item is immediately available.

A link 252 is provided whereby a user can order the item from a suitable website such as www.amazon.co.uk or www.amazon.com.

In another embodiment, the overall list 200 might include all items in a specific category, such as books in print, or all items having an EAN code or ISBN number. The list 200 would specify the items that have actually been offered for exchange by users

In another embodiment, the exchange could maintain an inventory of items offered for exchange by the exchange itself. Users could purchase items directly from the exchange and could sell items directly to the exchange.

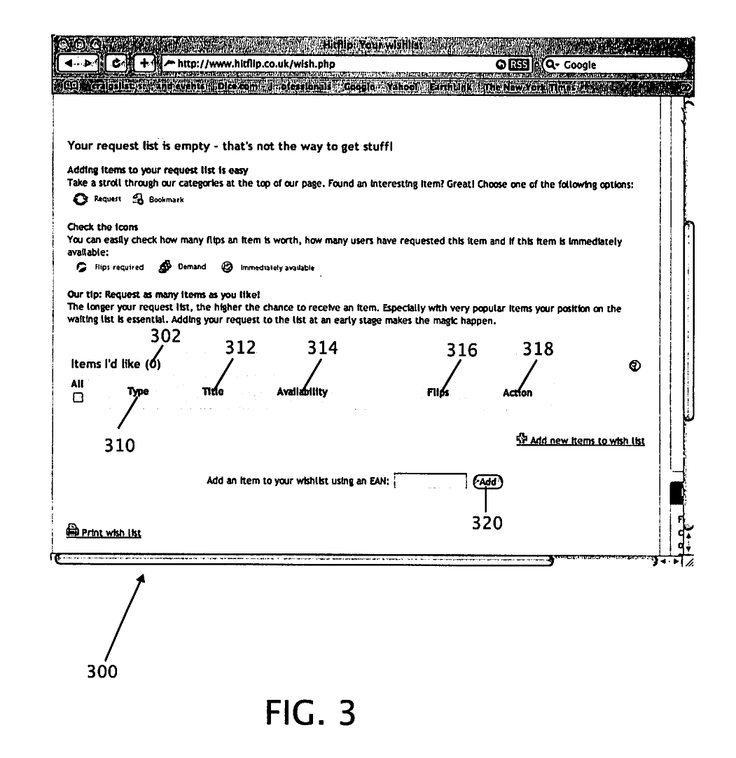

FIG. 3 is a pictorial illustration 300 of a wish list of goods desired for exchange by a user, according to a preferred embodiment of the present invention. The wish list 302 shows all items requested by the user. Each item is identified by type 310 (e.g., book), title 312, availability 314 (e.g., immediately available), number of flips required for exchange 316, and action taken 318 (e.g., sent to requester by another user).

A user can add items to her wish list in one of two ways. First, the user can click the request icon 226 that appears on the overall list 200 of items available for exchange, thereby requesting an item on the list. Second, the user may request an item by specifying the EAN code or ISBN number of that item using a facility on her wish list 302 interface. The second way allows a user to place an item on her wish list that has not been offered for exchange previously by another user.

When more than one user requests a particular item, the Hitflip central computer selects one user to receive the item when it becomes available. Other users requesting the same item are placed on a waiting list. In one embodiment, selection criteria include the date on which a user has requested an item, with preference given to earlier requests. In another embodiment, other criteria, such as past trading performance, may be used.

In one embodiment, items on a user's wish list 302 are selected only from the overall list 200 of items offered for exchange. The overall list 200 includes only items previously listed as immediately or potentially available for exchange by users of the exchange. In another embodiment, a user may place any item having an EAN code or ISBN number on her wish list. In such an embodiment, a user may place an item on her wish list 302 that has not been listed for exchange by any other user. If another user subsequently lists that item for exchange, the Hitflip central computer then arranges an exchange of that item.

In still another embodiment, a user might place an item on her wish list that is not identified by an EAN code or an ISBN number. Such an embodiment would include an interface using which a user could identify the desired item by type, name, and perhaps other information, such as automobile, 1957 Ford Thunderbird. Such an embodiment might also include an overall list of items desired for exchange, sorted by category, that could be perused by users who are considering offering items for exchange that are desired for exchange by other users.

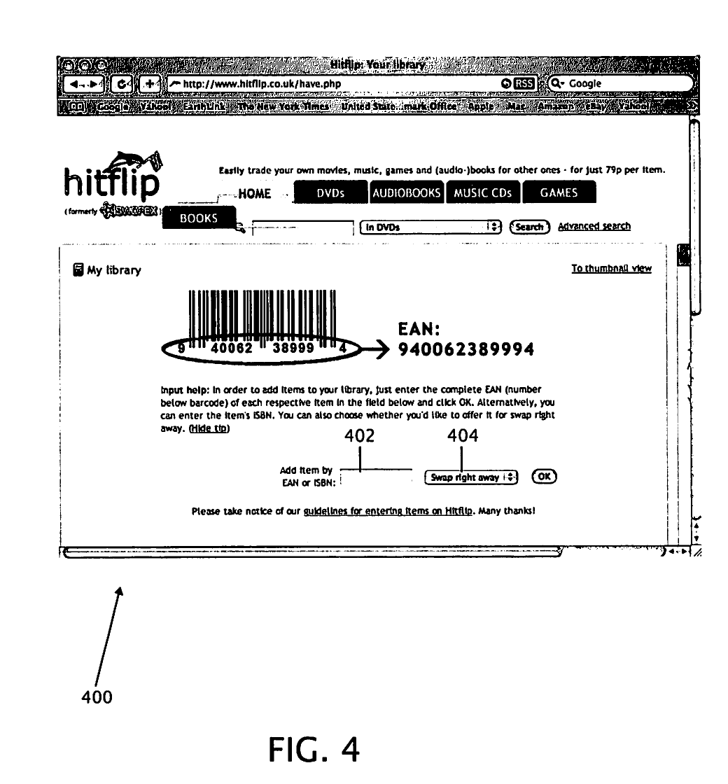

FIG. 4 is a pictorial illustration 400 of an interface for offering goods for exchange, according to a preferred embodiment of the present invention. The offering user identifies the item offered for exchange by EAN code or ISBN number 402 and specifies whether the offered item is immediately available 404 for exchange or only listed as potentially available for exchange. The offered item is added to the overall list of items available for exchange 200 and is also added to the library 500 of the offering user.

Standard EAN codes for a variety of products and ISBN numbers for books are well known to those skilled in the art and need not be described here.

The Hitflip central computer recovers the type, title, and other identifying information pertaining to a listed item from the EAN code or ISBN numbers provided by the offering user. The recovered identifying information is presented to users of the exchange on the overall list of items offered for exchange 200 and in the library 500 of the offering user.

In one embodiment, only items belonging to a limited set of pre-established categories (such as books or music CDs) may be offered for exchange. In another embodiment, any item having an EAN code or ISBN number may be offered for exchange.

The preferred embodiment uses EAN codes and ISBN numbers in the interests of precision, clarity, and unique identification of offered items. In still another embodiment, items offered for exchange need not be identified by EAN code or ISBN number. Such an embodiment would include an interface by which a user could identify an offered item by specifying its type, title, and other information, such as automobile, 1957 Ford Thunderbird, excellent condition. Such an embodiment is arguably more prone to vagueness and ambiguity than is the preferred embodiment. However, such an embodiment might be easier to use in certain cases, since a user need not know the EAN code or ISBN number of an item to list that item for exchange. Further, such an embodiment would permit offering items for exchange that do not have EAN codes or ISBN numbers.

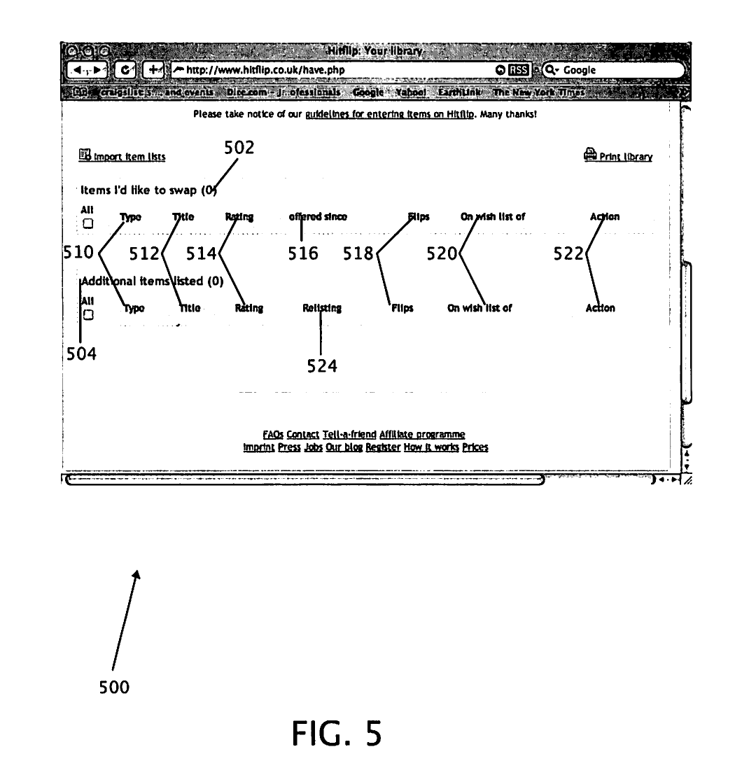

FIG. 5 is a pictorial illustration 500 of a library of all goods offered for exchange by a particular user, according to a preferred embodiment of the present invention. The library interface includes the interface of FIG. 4 (not shown) for adding items to the library 500. Items listed in the library 500 are sorted into those immediately available for exchange 502 and those only listed as potentially available for exchange 504. An item immediately available for exchange is identified by type 510 (e.g., book), title 512, rating 514, date item offered 516, number of flips required 518, individuals having that item on their wish lists 520, and action taken 522. An item listed that is only potentially available for exchange is identified by type 510, title 512, rating 514, number of flips required 518, individuals having that item on their wish lists 520, action taken 522, and by whether the item has been relisted 524.

In another embodiment, the library 500 of a user might include prose descriptions of items, excerpts of product reviews of items, and so on.

In the preferred embodiment, a user adds an item to her library by entering the EAN code or ISBN number of that item in the interface described above with reference to FIG. 4. The Hitflip central computer recovers the type and title, of the item from the EAN code or ISBN number of the item input by the user, and displays the recovered information in the user's library 500 interface. The central computer recovers the date the item was offered 516 from the date the item was entered in the library 500. The central computer recovers the individuals who have the item on their wish lists from the user database of the Hitflip system. The central computer obtains a rating of the item from a variety of sources, such as consumer product reviews.

Items listed in the library 500 of a user as immediately available for exchange are also listed as immediately available for exchange in the overall list 200 of items available for exchange described above with reference to FIG. 2. Other items listed in the library 500 of a user that are not immediately available for exchange but are only potentially available for exchange are also listed in the overall list 200 of items available for exchange, but are not identified as immediately available for exchange in the overall list 200 unless they are offered immediately for exchange by at least one user.

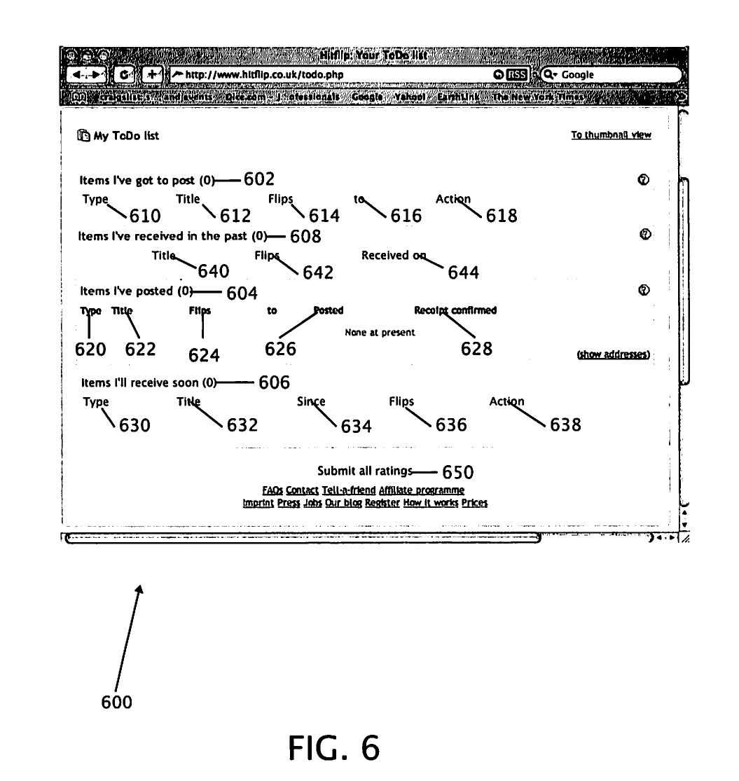

FIG. 6 is a pictorial illustration 600 of a task list that lists all outstanding tasks to be performed by a user, according to a preferred embodiment of the present invention. The task list 600 shows items 602 the user must mail to other requesting users, items 604 the user has already mailed to other requesting users, items 606 that have been sent to the user by other users but have not yet been received by the user, and items 608 that have been received previously by the user. Items to be mailed 602 are identified by type 610, title 612, number of flips required 614, individual 616 to whom item is to be mailed, and action taken 618. Items 604 that have been mailed are identified by type 620, title 622, number of flips required 624, date posted 626, and whether receipt has been confirmed 628. Items 606 to be received are identified by type 630, title 632, date mailed 634, number of flips required 636, and action taken 638. Items 608 previously received are identified by title 640, number of flips required 642, and date received 644. The task list permits a receiving user to rate 650 the sender of a received item.

When a first user sends an item to a second requesting user, the first user notifies Hitflip that the item has been sent. The Hitflip database is updated to reflect that the item has been sent. The Hitflip central computer updates the task list of the first user to indicate that the item has been sent, and also updates the task list of the second user to indicate that the item is to be received soon. In the preferred embodiment, the first user notifies Hitflip that an item has been sent by email, perhaps by responding to an email received by the first user from Hitflip directing the first user to send the item to the second user. In another embodiment, the first user could use a feature of the interface provided by Hitflip to update her task list herself.

When a second user receives an item sent by a first user, the second user uses a feature of the task list 600 interface to rate the performance of the first user. When the rating is received by Hitflip, the Hitflip database is updated to reflect the rating. The Hitflip central computer then modifies the task list of the first user to indicate that the item has been received by the second user, and modifies the task list of the second user to indicate that the item has been received and the date on which the item was received. In another embodiment, the users could use a feature of the interface provided by Hitflip to update their task lists themselves.

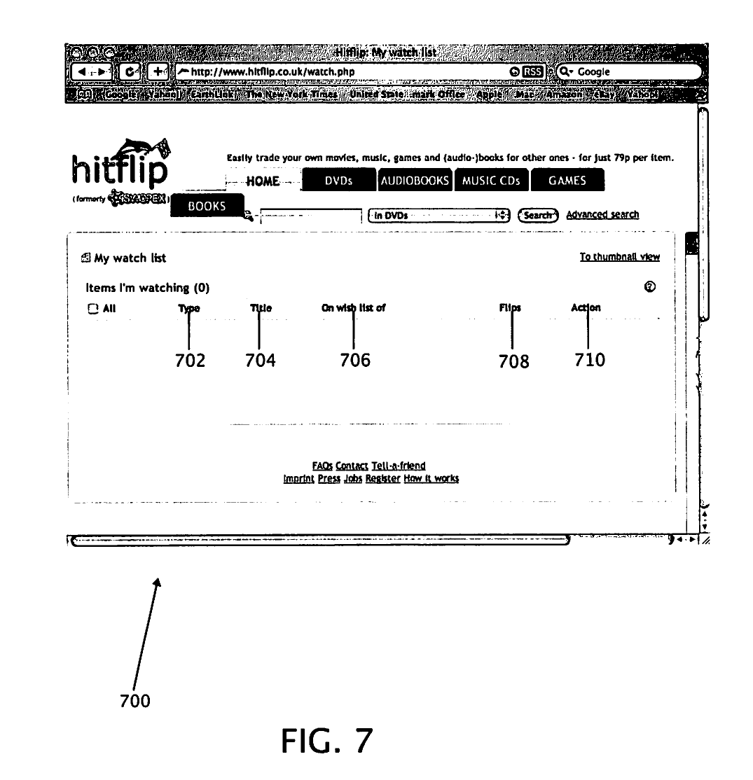

FIG. 7 is a pictorial illustration 700 of a watch list of items of interest to a user, according to a preferred embodiment of the present invention. The watch list 700 shows items on the overall list of items available for exchange 200 that have been bookmarked by the user. Items on the watch list 700 are identified by type 702, title 704, individuals having those items on their wish lists 706, number of flips required 708, and action taken 710.

The watch list 700 permits a user to keep track of items of interest without placing those items in her library 500 or on her wish list 300. For example, the user can monitor the number of other users who wish to acquire an item of interest or the current exchange value, in flips, of the item. The watch list 700 gives the user some idea of the amount of time she will have to wait to receive the item if she decides to acquire the item in the future—the larger the number of other users who desire the item, the longer the wait will be. The watch list 700 also tells the user how much the item will cost, should she decide to acquire it. The user can then make sure that she has enough flips in her account to acquire the item—the central computer will not select her to participate in an exchange of the item if she lacks sufficient flips.

Should the user wish to acquire an item on her watch list 700 at a later time, she can add the item to her wish list 300. Should the user wish to offer an item on her watch list 700 for exchange at a later time, she can add the item to her library 500.

In the preferred embodiment, only items on the overall list 200 of items available for exchange can be placed on a user's watch list 700. In another embodiment, the user could add an item to her watch list 700 by inputting the EAN code or ISBN number of the item, using an interface provided by the exchange. Such an embodiment could also show the availability of the item on the watch list 700. Such an embodiment would permit the user to note an item not currently available that she might like to acquire at a later time, without placing the item on her wish list 300, and would notify the user should the item become available. In this way, the user could monitor the availability of the item without committing herself to participate in an exchange.

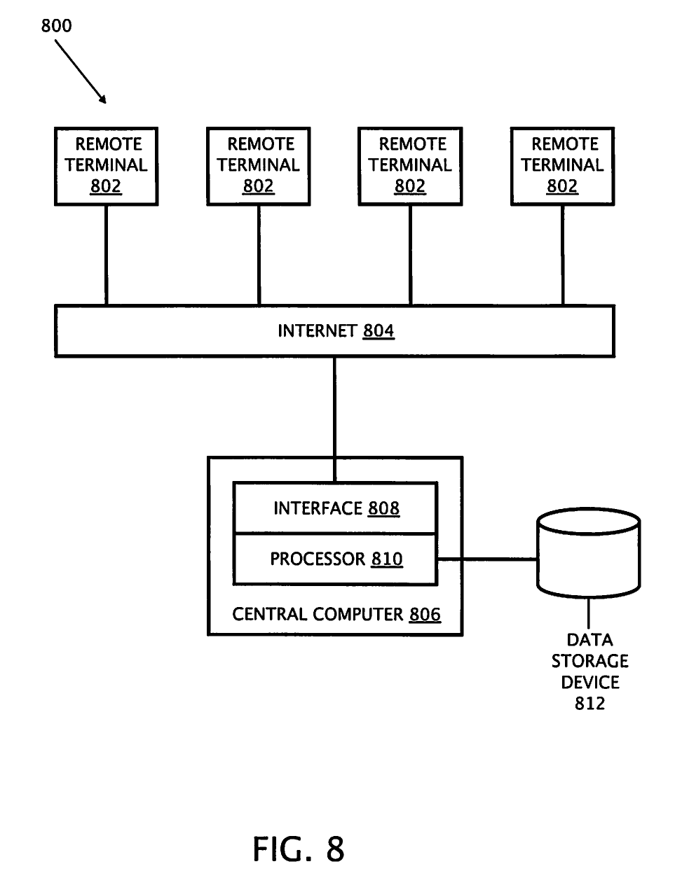

FIG. 8 is a diagram 800 of the system of the present invention, according to one embodiment of the invention. Remote terminals 802 having input devices for entering data are connected by the internet 804 to a central computer 806. The internet 806 is a data communications network providing a path for the exchange of data between the remote terminals 802 and the central computer 806. The central computer includes a processor 810 and an interface 808. The interface 808 is controlled by the processor 810 and is capable of sending data to and receiving data from the remote terminals 802.

A data storage device 812 is connected to the central computer 806. The data storage device stores data records such as information related to items offered for exchange, items desired for exchange, descriptions of items offered for exchange, user identification information, user wish lists, user libraries, user watch lists, user task lists, user accounts, records of exchanged items sent and received, and user ratings.

In the preferred embodiment, items offered or desired for exchange are identified by EAN codes or ISBN numbers. Such codes permit items to be identified precisely and uniquely. However, users may not always know the codes of items of interest, and some items of interest may not have such codes. In another embodiment, items are identified by type, title, and other information, such as author and edition for books. Such an embodiment might be more accessible to some users.

In one embodiment, user identification information includes name, email address, and mailing address. Further user information, such as transaction histories, date of birth, and gender, may also be stored.

The central computer 806 receives data entries identifying items offered for exchange input at the remote terminals 802 by users. The central computer 806 then analyzes the data records to determine whether there are data records specifying the items offered for exchange as desired for exchange by other users. If so, the processor 810 selects users offering and desiring the same items to participate in exchanges.

In the system shown in FIG. 8, the remote terminals 802 typically are computers. The processor 810 includes a central processing unit and associated memory. The data storage device 812 includes a hard disk drive on which data records are stored in a database.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

We claim:

1. A computer-implemented method of exchanging goods over the internet, comprising:
providing and maintaining an exchange for transfer of ownership of items over the internet, said exchange comprising:
providing, maintaining, and updating a first list of items available for exchange;
receiving data entries from a first plurality of users identifying a first plurality of exchange items offered for exchange, where said plurality of exchange items are identified by EAN codes or ISBN numbers;
maintaining and updating in a database, for each user of the exchange, a separate library listing all items offered for exchange by each user, said library for a user comprising all items offered for exchange by said user that belong to said first plurality of exchange items;
receiving data entries from a second plurality of users identifying a second plurality of exchange items desired for exchange, where said items are selected from said first list of items available for exchange, or are identified by EAN codes or ISBN numbers input by said second plurality of users;
maintaining and updating in said database, for each user of the exchange, a separate wish list of items desired for exchange by each user;
maintaining and updating in said database, for each user of the exchange, a separate watch list of items of interest that are not immediately desired by each user;
maintaining and updating in said database, for each user of the exchange, a separate task list that lists all outstanding tasks to be performed by each user;
providing and maintaining a medium of exchange;
assigning an exchange value to each item available for exchange in terms of said medium of exchange;
providing, maintaining, and updating an account for each user of the exchange;
searching said database to identify a first item that has been offered for exchange by at least one user and is desired for exchange by at least one user;
selecting a first user who offers said first item for exchange to participate in an exchange of said first item;
selecting a second user who desires said first item for exchange to participate in an exchange of said first item with said first user;
communicating contact information regarding said second user to said first user and instructing said first user to send said first item to said second user;
debiting said exchange value of said first item from the account of said second user;
crediting said exchange value of said first item to the account of said first user;
assessing a transaction fee to said second user;
notifying said second user when said first user sends said first item to said second user; and
providing and maintaining an internet web site to facilitate said exchange, wherein said first list of items available for exchange, said libraries, said wish lists, said watch lists, and said task lists are accessed via interface web pages on said web site.

2. The method of claim 1, wherein an item offered for exchange can be classified by a user offering said item for exchange as either available immediately for exchange or merely listed as potentially available for exchange.

3. The method of claim 1, wherein the first list of items available for exchange consists of items selected from the group consisting of: a book, a DVD, an audiobook, a music CD, and a game.

4. The method of claim 1, wherein flips may be obtained by users by sending items offered for exchange to users desiring said items or by purchasing said flips directly from the exchange.

5. The method of claim 1, wherein the first list of items available for exchange includes every item offered for exchange by every user of the exchange.

6. The method of claim 1, wherein the first user and the second user are registered users of the exchange, and wherein only registered users may exchange items.

7. The method of claim 1, wherein a user of the exchange becomes a registered user of the exchange by providing the exchange with a name, an email address, a password, and an optional mailing address.

8. The method of claim 1, wherein items offered for exchange are input into libraries by users through an internet browser interface.

9. The method of claim 1, wherein items desired for exchange are input into wish lists by users through an internet browser interface.

10. The method of claim 1, wherein items of interest are input into watch lists by users through an internet browser interface.

11. The method of claim 1, wherein said contact information regarding said second user communicated to said first user includes the name and mailing address of said second user.

12. The method of claim 1, wherein all of the steps of inputting items into libraries, wish lists, and watch lists are contingent on a user entering a valid password.

13. The method of claim 1, wherein the exchange guarantees that all items transferred are in good working condition and will issue a refund including transaction fees if a user receives a defective item.

14. A system for exchanging goods over the internet, comprising:
a central computer;
a plurality of remote terminals, each of said remote terminals having input devices for entering data;
a data communication network providing a path for data exchange between said central computer and said remote terminals;
a processor located at said central computer;
an interface located at said central computer, said interface being controlled by said processor, wherein said interface is capable of providing data to and receiving data from said remote terminals;
a data storage device connected to said central computer, said data storage device being controlled by said processor, and said data storage device storing data records comprising information related to at least one of: items offered for exchange, items desired for exchange, descriptions of items, and user identification;
said central computer receiving a data entry identifying an item offered for exchange input at one of said plurality of remote terminals by a first user;
said processor analyzing the data records to determine whether there is a data record specifying said item offered for exchange as desired for exchange by a second user; and,
if so, said processor selecting a user offering said item and a user desiring said item to participate in an exchange of said item.

15. The system of claim 14, wherein said remote terminals are computers, and users at said remote terminals input and receive data from said central computer via an internet browser interface.

16. The system of claim 14, wherein said processor comprises a central processing unit and associated memory.

17. The system of claim 14, wherein said data storage device comprises a hard disk drive, and the data records are stored in a database stored on said hard disk drive.

18. The system of claim 14, wherein said first user must enter a valid password before the system will accept the input of data relating to an item offered for exchange.

19. The system of claim 14, wherein said second user must enter a valid password before the system will accept the input of data relating to an item desired for exchange.
